(19) United States
(12) Patent Application Publication
(10) Pub. No.: US 2024/0234965 A1
(43) Pub. Date: Jul. 11, 2024

(54) Method and Device for Providing a Battery for an Electrically Operable Motor Vehicle

(71) Applicant: MERCEDES-BENZ GROUP AG, Stuttgart (DE)

(72) Inventor: Dirk STEFFENS, Weinstadt (DE)

(21) Appl. No.: 18/002,521

(22) PCT Filed: Jun. 8, 2021
(86) PCT No.: PCT/EP2021/065364

§ 371 Date: Dec. 20, 2022

(30) Foreign Application Priority Data
Jun. 29, 2020 (DE) 10 2020 003 886.7

(51) Int. Cl. H01M 50/517; H01M 50/249; H01M 50/526

(52) U.S. Cl. CPC H01M 50/517; H01M 50/249; H01M 50/526; H01M 2220/20

(57) ABSTRACT

A method for providing a battery for an electrically operable motor vehicle, where a plurality of battery cells are disposed together to form a battery pack and where a plurality of dies are respectively disposed in a respective element of the plurality of battery cells, includes simultaneously connecting all dies of the plurality of dies that are disposed on a same side of the battery pack with at least one component via press joining by a tool.

### BACKGROUND AND SUMMARY OF THE INVENTION

The invention relates to a method for providing a battery for an electrically operable motor vehicle, as well as a device for providing a battery for an electrically operable motor vehicle.

DE 10 2016 011 787 A1 already discloses a block of cells for a motor vehicle battery having at least one battery cell, having at least one cell holder for securing the at least one battery cell, as well as having at least two live components that are joined by deformation, which are electrically connected with the at least one battery cell. Furthermore, the block of cells comprises at least one die element that is at least partially arranged in a connecting region of the live components. The die element is to be understood to mean an element which served as a die during joining of the live components by deformation. Here, the die describes a tool counterpart of a tool, in particular for a stamp for a deforming process. The at least one die element is at least partially integrated into the at least one cell holder, in particular it is formed integrally with the cell holder. The two live components are joined by means of press joining, for example by means of clinching or tox clinching.

It is the object of the present invention to create a method as well as a device for providing a battery for an electrically operable motor vehicle, by means of which respective battery cells of a battery pack are especially quickly electrically contactable.

The invention relates to a method for providing a battery for an electrically operable motor vehicle in which a plurality of battery cells are arranged together to form a battery pack, several dies are inserted into at least one element of the battery, and the battery cells are electrically connected with one another by means of press joining, via at least one further component. Due to the insertion of the dies into the at least one element of the battery, the battery cells can be electrically contacted by means of press joining on one side. Respective cell arrestors can be positively connected with the element of the battery that has the die by means of press joining. In particular, the at least one cell arrestor can be stamped into the respective die provided by the element by means of a stamp, whereby the at least one cell arrestor is press-joined with the element that has the die.

In order to electrically contact the battery cells of the battery or to be able to produce an electrical connection of the battery cells in an especially short assembly time, it is provided according to the invention that, by means of a tool, all dies that are arranged on a same side of the battery pack are simultaneously connected with the at least one further component via press joining. This means that at least one of the battery cells is simultaneously electrically contacted in several different locations by means of the tool. To this end, the tool comprises several stamps by means of which a battery pack of the battery comprising several battery cells is simultaneously press-joined to several, in particular in a plurality, of locations, in particular with an electrically conductive material, in order to electrically connect the battery cells of the battery pack with one another. This tool, which has several stamps, can in particular be formed insulated against a short circuit. The method thus enables an especially fast electrical contacting of, in particular, several battery cells of a battery pack of a battery, whereby the battery can be deployed especially quickly. The battery is in particular a vehicle battery, the individual battery cells of which are to be connected with respective cell arrestors by means of press joining. In the method for providing the battery, the dies are inserted into a cell frame or a block of cells as elements of the battery, so that, taking advantage of the one-sided access, the tool can clinch directly into the battery pack. In the method, a multi-stamp tool is used, which can complete all the clinch points arranged on one side of the battery pack in one cycle, whereby an especially low cycle time can be achieved. In the method, electrical insulation can be arranged on the battery pack, in addition to electrical contacting, by means of the press joining.

The invention further relates to a device for providing a battery for an electrically operable motor vehicle having a receiving arrangement by means of which a plurality of battery cells can be accommodated arranged together to form a battery pack. Furthermore, the device comprises a stamping device, by means of which the battery cells can simultaneously be electrically connected with one another at several different locations via at least one further component of the battery by means of press joining, wherein at least one element of the battery provides respective dies for the press joining. Here, a cell frame or a block of cells of the battery can, for example, have the several dies via which the battery cells are electrically contactable, by means of the clinch connections and thus by means of the press joining. The stamping device is in particular configured to simultaneously connect dies all arranged on the same side of the battery pack with the at least one further component by means of press joining.

Advantages and advantageous developments of the method according to the invention are to be seen as advantages and advantageous developments of the device according to the invention and vice versa. For this reason, the further advantages and advantageous embodiments of the device according to the invention are not described again here.

Further advantages, features and details of the invention arise from the following description of a preferred exemplary embodiment, as well as with the aid of the drawings. The features and feature combinations referred to above in the description, as well as the features and feature combinations referred to below in the description of the figures and/or shown solely in the figures can be used not only in each specified combination but also in other combinations or alone, without leaving the scope of the invention.

### BRIEF DESCRIPTION OF THE DRAWINGS

FIG. 1 shows a process diagram for press joining a battery with one-sided access, wherein a first cell arrestor and a second cell arrestor are connected with a cell frame or a block of cells made of plastic via the press joining, in order to electrically contact several battery cells of the battery; and

FIG. 2 shows a process diagram for simultaneously press joining several battery cells by means of a tool in one single cycle.

### DETAILED DESCRIPTION OF THE DRAWINGS

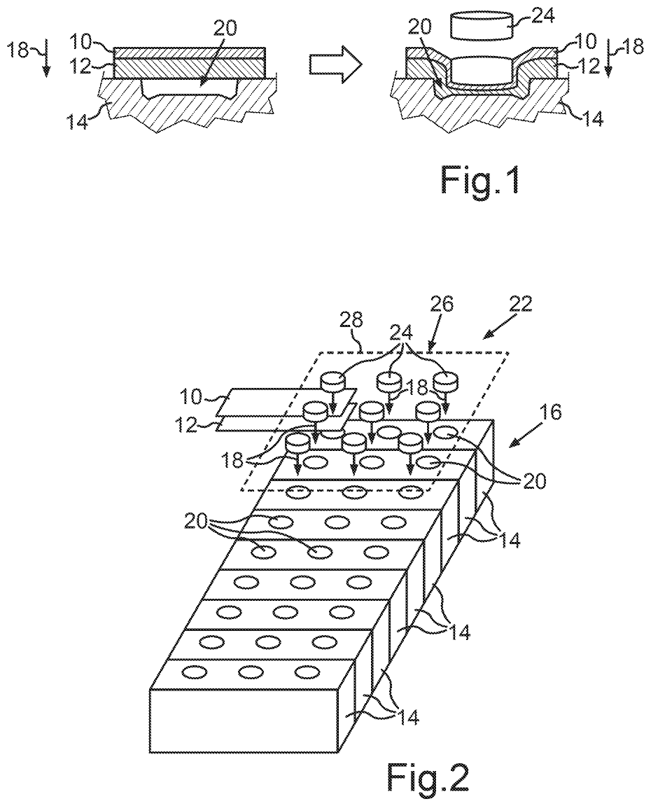

In FIG. 1 is shown a method for press joining a first cell arrestor as a first component 10 and a second cell arrestor as a second component 12 to a battery cell 14 of a battery pack 16 of a battery. The respective battery cells 14 are electrically contacted with the components 10, 12 by means of the press joining. The press joining, which can also be referred to as clinching, is an efficient solution to positively connect the components 10, 12 in a continuous deformation process and to partially integrally connect them with the battery pack 16. The press joining enables several positions of respective components 10, 12 to be able to be reliably connected with one another. Since the press joining takes place without heat input, a delay in a component being press-joined can, at least substantially, be avoided. Furthermore, thermally sensitive materials can, during the press joining, be arranged in close proximity to a position at which the press joining is being carried out.

Herein, an electrical contacting of battery cells 14 of the battery pack 16 occurs via the press joining. Here, the battery pack 16 is part of a vehicle battery of a motor vehicle. Electrical energy for powering the motor vehicle can be supplied by means of the battery. In order to be able to electrically contact the battery cells 14, the first component 10 is stacked on the second component 12 in a joining direction 18 and the components 10, 12 are arranged on the battery cell 14, covering one of the dies 20 provided by the battery cell 14 in the joining direction 18. Subsequently, as can be seen in FIG. 1, at least one stamp 24 is positioned on one of the components 10, 12 in the joining direction 18 by means of a tool 22 and the components 10, 12 are pressed onto the die 20 provided by the battery cell 14. A positive-locking fit between the components 10, 12 as well as with the die 20 of the battery cell 14 thereby occurs. After such a press joining of the components 10, 12 with the battery cell 14, the stamp 24 is detached from the components 10, 12. The first component 10 is a first cell arrestor, which is herein formed from copper or aluminium. The second component 12 is a second cell arrestor, which is herein formed from aluminium or copper. The cell arrestors have electrical contact with the battery cell 14 via the press joining. The contacted battery cell 14 can be interconnected with further battery cells 14 via the electrical contacting of the respective battery cell 14, in particular in series connection or parallel connection.

In order to provide the battery for the motor vehicle, as is shown in FIG. 2, several battery cells 14 are arranged, in particular stacked, one on top of the other to form the battery pack 16. It is furthermore provided that the dies 20 are inserted into the respective cell frame of the battery cells 14. Here, the dies 20 can be inserted into the cell frame, before or after the battery cells 14 are stacked to form the battery pack 16. Herein, the cell frame is advantageously made of plastic components. The dies 20 can be shaped into these plastic components, during production of the plastic components, for example during an injection moulding process.

The first component 10 and the second component 12 are stacked one above the other in the joining direction 18 and positioned on the battery pack 16, whereby the components 10, 12 cover several dies 20 in the joining direction 18. In particular, the components 10, 12 cover all of the dies 20 arranged on one side of the battery pack 16. All of the dies 20 arranged on the same side of the battery pack 16 can be simultaneously connected with the components 10, 12 by means of press joining, by means of a tool 22, which, here, comprises a stamping device 26 having a plurality of stamps 24. In the present FIG. 2, the stamping device 26 of the tool 22 is only shown in part, for especially good clarity. Here, the tool 22 comprises a receiving arrangement by means of which the majority of battery cells 14 that are arranged one on top of the other in the battery pack 16 can be accommodated. The components 10, 12 can be simultaneously press-joined to the dies 20 of the battery pack 16 by means of the stamping device 26 of the tool 22, with the plurality of stamps 24. Here, the stamping device 26 comprises at least as many stamps 24 as the battery pack 16 has dies 20 on the side that electrically contacts with the components 10, 12. In order to avoid a short circuit, the tool 22 has, in addition to the stamping device 26, insulation 28 by means of which the stamps 24 can be electrically insulated from one another as well as from the electronics of the tool 22.

The tool 22 described, which is a device for providing a battery for an electrically operable motor vehicle, as well as the method described, is based on the knowledge that producing electric contacts on battery cells 14 by means of press joining, which can also be referred to as clinching, involves disadvantages regarding the access as well as an especially high cycle time when there is access for stamps and dies on both sides. In order to be able to implement especially short cycle times when connecting electrical contacts, it is provided that the dies 20 are inserted into the battery pack 16 in the method for providing the battery, so that they can clinch directly into the battery pack 16. Here, a one-sided access to the battery pack 16 is taken advantage of for the press joining. In order to electrically contact the battery cells 14 of the battery pack 16, the tool 22 is used, which is a multi-stamp tool, which can complete all of the clinch points corresponding to one side of the battery pack 16 in a single cycle, whereby especially short cycle times can be achieved. Insulation can be applied to respective joints of the press joining by means of the tool 22.

The method described is an especially cost-effective joining method, since only a single stamp tool, here the tool 22, is used. Furthermore, a complex die tool for providing respective counter-support for the stamp 24 can be eliminated. Including a die in cell frames of the battery cells 14 can be especially easily executed in this manufacturing process. The tool 22 described can be used for a wide variety of material combinations and arrangements. Furthermore, the tool 22 enables an especially high quality of connection and can be used with conventional systems engineering. The tool 22 enables an especially simple process sequence for electrical contacting of the battery cells 14.

Overall, the invention shows how a method and a device for contacting of battery cells 14 can be achieved.

### LIST OF REFERENCE CHARACTERS

10 First component
12 Second component
14 Battery cell
16 Battery pack
18 Joining direction
20 Die
22 Tool
24 Stamp
26 Stamping device
28 Insulation

1.-5. (canceled)

6. A method for providing a battery for an electrically operable motor vehicle, wherein a plurality of battery cells (14) are disposed together to form a battery pack (16) and wherein a plurality of dies (20) are respectively disposed in a respective element of the plurality of battery cells (14), comprising the step of:
simultaneously connecting all dies of the plurality of dies (20) that are disposed on a same side of the battery pack (16) with at least one component (10, 12) via press joining by a tool (22).

7. The method according to claim 6, wherein the at least one component (10, 12) comprises a first component (10) and a second component (12).

8. The method according to claim 7, wherein the first component (10) and the second component (12) are stacked one on top of the other in a joining direction (18) and are subsequently press-joined with the respective element of the plurality of battery cells (14) in the joining direction (18).

9. A device for providing a battery for an electrically operable motor vehicle, comprising:
a receiving arrangement, wherein a plurality of battery cells (14) are receivable and arrangeable together in the receiving arrangement to form a battery pack (16); and
a stamping device (26), wherein a plurality of battery cells (14) that are received and arranged together in the receiving arrangement are simultaneously electrically connectable with one another at a plurality of locations by press joining by the stamping device (26) and wherein a respective die of the plurality of battery cells (14) is respectively disposed at the plurality of locations.

10. The device according to claim 9, wherein the plurality of locations are disposed on a same side of the plurality of battery cells (14).
